(19) United States
(12) Patent Application Publication
(10) Pub. No.: US 2012/0178290 A1
(43) Pub. Date: Jul. 12, 2012

(54) SOLAR POWER CABLE CONNECTOR

(76) Inventor: Chih-min Yu, Tainan City (TW)

(21) Appl. No.: 13/004,467

(22) Filed: Jan. 11, 2011

(51) Int. Cl. H01R 13/52

(52) U.S. Cl. 439/587

(57) ABSTRACT

A waterproof solar power cable connector includes a first connection member, a clamping member, a waterproof member and a second connection member. The first connection member includes two open ends and a tapered inner periphery. The clamping member is received in the first connection member and has a ring from which multiple resilient pieces extend. The waterproof member is inserted into the first connection member and clamped by the resilient pieces of the clamping member. The ring of the clamping member is matched with the engaging portion of the waterproof member. The second connection member is connected to the first connection member. The second connection member has a contact surface which is matched with the engaging portion of the waterproof member so as to seal the connection between the inner periphery of the first connection member and the waterproof member to prevent from watering entering to damage the cable.

### FIELD OF THE INVENTION

The present invention relates to a solar power cable connector, and more particularly, to a waterproof solar power cable connector.

### BACKGROUND OF THE INVENTION

A conventional waterproof connector as disclosed in Taiwan Patent Published No. M351495 includes a body which is inserted into a connection member with multiple boundary portions. The connection member has one end to accommodate a waterproof washer and a connection piece. The connection piece has multiple spaced clamping portions at the function end thereof and a ring is engaged with the periphery of the clamping portions. The threaded section of the connection piece is threadedly connected with a cap which includes an opening. The connection member accommodates the waterproof washer and a nut in the other end thereof. The ring has better expendability by the at least one section thereof so that the cable is easily assembled to the connector. The at least one section is also helpful to expel air outward to form a certain vacuum status in the connector so that the connector is waterproof and airtight.

A water-proof device of signal connector is disclosed in Taiwan Patent Published No. M270535 and includes a sleeve which has the front end thereof connected to a signal jack, and the rear end thereof connected with a resilient urging portion. A waterproof member is inserted into the resilient urging portion and a clamping member is mounted to the outside of the rear end of the sleeve to urge the waterproof member against the cable of the signal plug. The waterproof device is easily installed by mounting the waterproof member to the end of the cable and the clamping member is then mounted to the outside of the rear end of the sleeve.

Nevertheless, the shortcomings of the conventional waterproof devices are that the waterproof member is not separated from the connector, and the waterproof member or the ring is easily damaged and cannot be replaced.

The second conventional waterproof device of signal connector disclosed in Taiwan Patent Published No. M270530, the outer surface of the waterproof member is smooth so that when the clamping member is mounted and applied by a torsion force, there will be a gap defined between the waterproof member and the sleeve to easily short the circuit or damage electronic parts.

The present invention intends to provide a waterproof solar power cable connector which improves the shortcomings of the conventional products.

### SUMMARY OF THE INVENTION

The present invention relates to a waterproof solar power cable connector and comprises a first connection member, a clamping member, a waterproof member and a second connection member. The first connection member includes two open ends and a tapered inner periphery. The first connection member further has a first connection portion. The clamping member is received in the first connection member and has a ring from which multiple resilient pieces extend. The waterproof member is a resilient member with two open ends and an engaging portion is located on one end thereof. The waterproof member is inserted into the first connection member and clamped by the resilient pieces of the clamping member. The ring of the clamping member is matched with the engaging portion of the waterproof member. The second connection member has a second connection portion which is connected with the first connection portion of the first connection member. The second connection member has a contact surface which is matched with the engaging portion of the waterproof member so as to seal the connection between the inner periphery of the first connection member and the waterproof member to prevent from watering entering to damage the cable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the solar power cable connector of the present invention;

FIG. 2 is a perspective view to show the solar power cable connector of the present invention;

FIG. 3 is a cross-sectional view of the solar power cable connector of the present invention, and

FIG. 4 is a cross-sectional view to show that the solar power cable connector of the present invention is connected with a cable.

### DETAILED DESCRIPTION OF THE PREFERRED EMBODIMENT

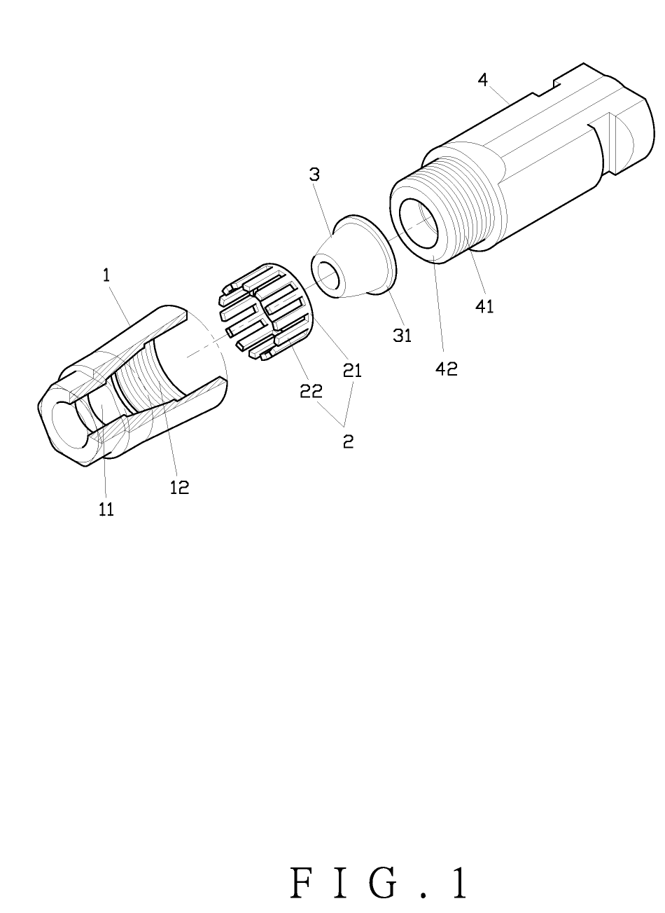

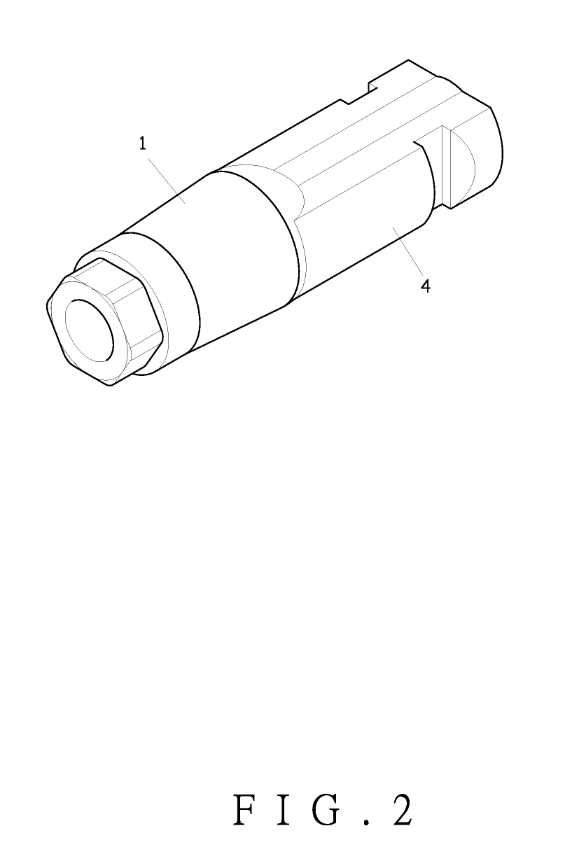

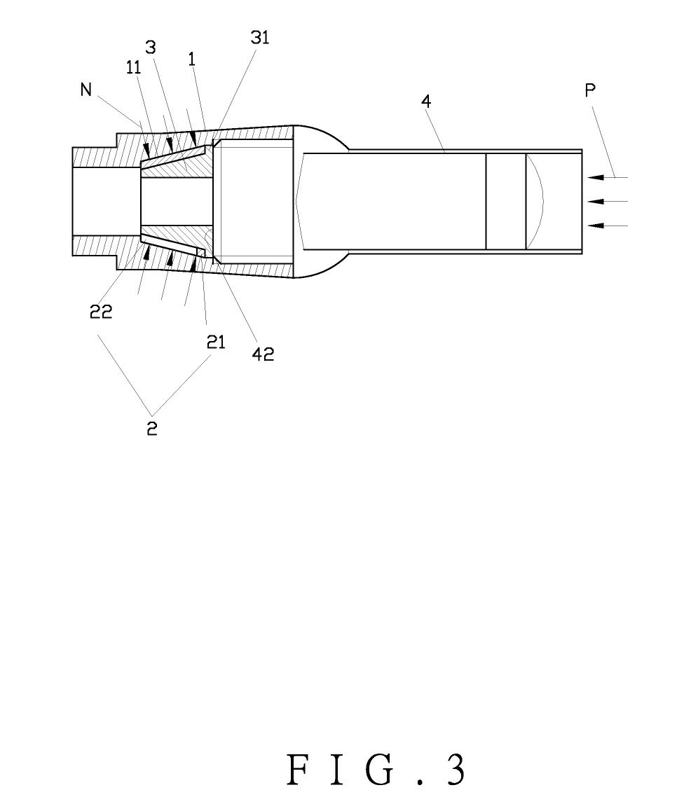

Referring to FIGS. 1 to 3, the waterproof solar power cable connector of the present invention comprises a first connection member 1, a clamping member 2, a waterproof member 3, and a second connection member 4.

The first connection member 1 has two open ends and a tapered inner periphery 11. A first connection portion 12 is defined in an end open end of the first connection member 1.

The clamping member 2 is received in the first connection member 1 and has a ring 21. Multiple resilient pieces 22 extend from the ring 21.

The waterproof member 3 is a resilient member with two open ends. An engaging portion 31 is located on an end of the waterproof member 3. The waterproof member 3 is inserted into the first connection member 1 and clamped by the resilient pieces 22 of the clamping member 2. The waterproof member 3 is a cone-shaped member and the engaging portion 31 is a flange extending outward from the end with maximum diameter.

The second connection member 4 has a second connection portion 41 which is connected to the first connection portion 12 of the first connection member 1. The second connection member 4 has a contact surface 42. When the first and second connection members 1, 4 are connected to each other, the ring 21 of the clamping member 2 is matched with the engaging portion 31 of the waterproof member 3 to seal connection between the inner periphery 11 of the first connection member 1 and the waterproof member 3. The engaging portion 31 is snugly matched the contact surface 42.

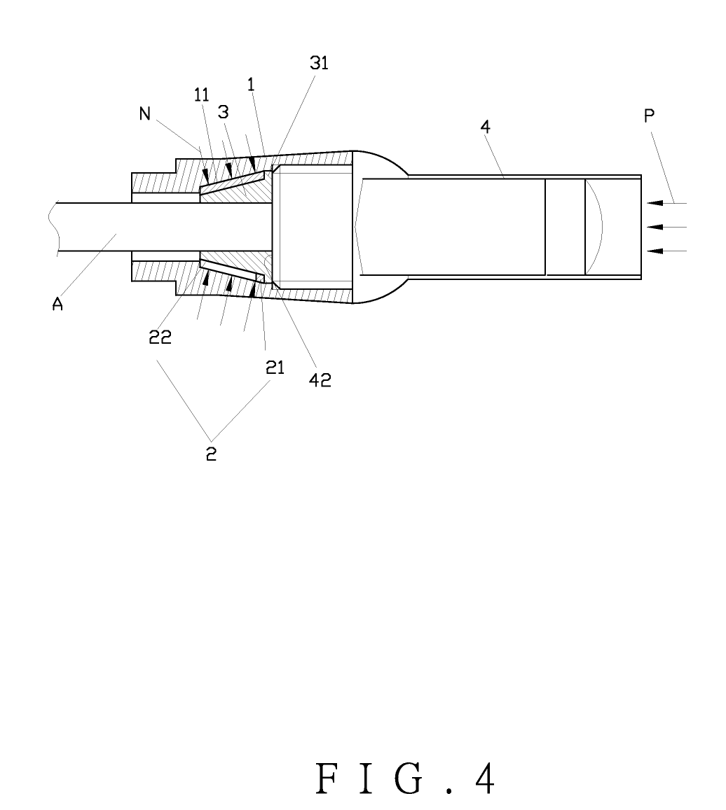

As shown in FIG. 4, the first connection portion 12 of the first connection member 1 is an inner threaded section and the second connection portion 42 of the second connection member 4 is an outer threaded section. The cable “A” extends through the second connection member 4 and extends out from the first connection member 1. When the first and the second connection members 1, 4 are threadedly connected to each other, the tapered inner periphery 11 of the first connection member 1 applies an orthogonal force “N” to the clamping member 2 and the waterproof member 3, and the threaded connection of the first and second connection members 1, 4 applies an axial force “P” to the clamping member 2 and the waterproof member 3. By the orthogonal force “N” and the axial force “P”, the inner periphery 11 of the first connection member 1 and the clamping member 2, and the waterproof member 3 and the contact surface 42 of the second connection portion 41 are respectively snugly in contact with each other. The ring 21 of the clamping member 2 and the engaging portion 31 of the waterproof member 3 are matched to each other so as to be waterproof and airtight and to form a vacuum status.

While we have shown and described the embodiment in accordance with the present invention, it should be clear to those skilled in the art that further embodiments may be made without departing from the scope of the present invention.

What is claimed is:

1. A waterproof solar power cable connector comprising:
a first connection member having two open ends and a tapered inner periphery, a first connection portion defined in an end open end of the first connection member;
a clamping member received in the first connection member and having a ring, multiple resilient pieces extending from the ring;
a waterproof member being a resilient member with two open ends, an engaging portion located on an end of the waterproof member, the waterproof member inserted into the first connection member and clamped by the resilient pieces of the clamping member, and
a second connection member having a second connection portion which is connected to the first connection portion of the first connection member, the second connection member having a contact surface, wherein when the first and second connection members are connected to each other, the ring of the clamping member is matched with the engaging portion of the waterproof member to seal connection between the inner periphery of the first connection member and the waterproof member, the ring snugly matching the contact surface.

2. The connector as claimed in claim 1, wherein the waterproof member is a cone-shaped member and the engaging portion is a flange extending outward from the end with maximum diameter.
